(19) United States
(12) Patent Application Publication
(10) Pub. No.: US 2013/0162077 A1
(43) Pub. Date: Jun. 27, 2013

(54) SPINDLE MOTOR

(71) Applicant: Samsung Electro-Mechanics CO., LTD., Suwon (KR)

(72) Inventor: Dong Jin Park, Suwon (KR)

(73) Assignee: Samsung Electro-Mechanics CO., LTD., Suwon (KR)

(21) Appl. No.: 13/706,914

(22) Filed: Dec. 6, 2012

(30) Foreign Application Priority Data
Dec. 26, 2011 (KR) 10-2011-0142663

(51) Int. Cl. H02K 5/16

(52) U.S. Cl. CPC H02K 5/16
USPC 310/89

(57) ABSTRACT

Disclosed herein is a spindle motor including a shaft; a sleeve having a hollow cylindrical shape so as to rotatably support the shaft; and a cover closing an opened lower portion of the sleeve. This spindle motor is characterized in that the cover and a lower portion of the sleeve are arranged in parallel with each other and adhered to each other by a horizontal butt welding method.

### CROSS REFERENCE TO RELATED APPLICATION

This application claims the benefit of Korean Patent Application No. 10-2011-0142663, filed on Dec. 26, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor is mounted in a device requiring high-speed rotation such as a hard disk drive (HDD), an optical disk drive (ODD), and the like, to rotate a disk of the HDD in which information is recorded and stored.

That is, the spindle motor is a device rotating the disk so as to make it possible to read data recorded in the disk by means of a head. More specifically, when current is applied to a core, a magnetic field is generated. In addition, this magnetic field provides magnetic force to a magnet provided in a rotor, and then the motor is rotationally driven based on the operation principle that a rotor is rotated by this magnetic force.

An example of this spindle motor is disclosed in Patent Document 1.

The spindle motor according to the prior art driven based on the principle as described above is configured to include a stator, a shaft, a sleeve, and the rotor, wherein the sleeve is formed to have a hollow hole in a cylindrical shape so as to rotatably support the shaft, and the shaft is rotatably inserted into the hollow hole of the sleeve.

As disclosed in Patent Document 1, in the sleeve, generally, a lower end thereof is closed via a cover, wherein the cover is fixed to the lower end of the sleeve in various methods such as widely known welding, caulking, bonding, or the like.

In order to assist in coupling between the sleeve and the cover, the sleeve includes a seating groove part formed at a lower portion thereof. The seating groove part is formed with a ring shaped step at the lower portion of the sleeve, and an outer peripheral portion of the cover is fixedly positioned on the step.

The cover includes a wing part bent at an outer peripheral surface thereof so as to be seated on the seating groove part formed with the step at the lower portion of the sleeve.

The cover seated on the seating groove part of the sleeve and the seating groove part may be fixed to each other by various methods, for example, a bonding adhesive method, a laser welding method, or the like, and recently, a butt laser welding method is mainly used rather than the bonding adhesive method.

The butt laser welding is performed by butting a cross-section of the cover seated on the seating groove part and a cross-section of the sleeve and then bonding the cross-sections. In this case, at the time of welding, deformation that the sleeve is decreased in an inner diameter direction but the cover is increased in an outer diameter direction may be generated.

This deformation changes a structural shape of the sleeve, such that an assembling state of the shaft in the sleeve may become incomplete, and an unexpected characteristic fault may occur in the rotation of the motor. Therefore, other solutions capable of solving these problems should be developed.

### PRIOR ART DOCUMENT

### Patent Document

(Patent Document 1) Korean Patent Laid-Open Publication No. 10-1038787

### SUMMARY OF THE INVENTION

The present invention has been made in an effort to provide a spindle motor capable of improving a welding state of a sleeve and a cover.

According to the present invention, at the time of welding a sleeve and a cover, the sleeve and the cover are not welded in a vertical direction as the prior art but may be welded in a horizontal direction.

According to a preferred embodiment of the present invention, there is provided a spindle motor including a shaft; a sleeve having a hollow cylindrical shape so as to rotatably support the shaft; and a cover closing an opened lower portion of the sleeve, wherein the cover is arranged in parallel with a lower portion of the sleeve to be fixed thereto.

In order to completely cover the lower portion of the sleeve, the cover may have a size corresponding to that of the lower portion of the sleeve.

Preferably, an outer peripheral surface of the lower portion of the sleeve and an edge of the cover is disposed to coincide with each other. Then, a junction of an outer peripheral surface of an upper portion of the cover and the outer peripheral surface of the lower portion of the sleeve is adhered by a welding method, particularly, a horizontal butt welding method.

As described above, the sleeve and the cover arranged in the vertical direction (or an axial direction) are welded in the horizontal direction and are pressurized in the horizontal direction at the time of welding, such that deformation of each of the components may be minimized.

The cover may be provided with a flat surface and a wing part bent near an outer peripheral surface of the flat surface, and a space between the flat surface and the wing part may be used as a space capable of receiving axial deformation caused by the horizontal butt welding.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view of a spindle motor; and

FIG. 2 is a partially enlarged view of the spindle motor shown in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

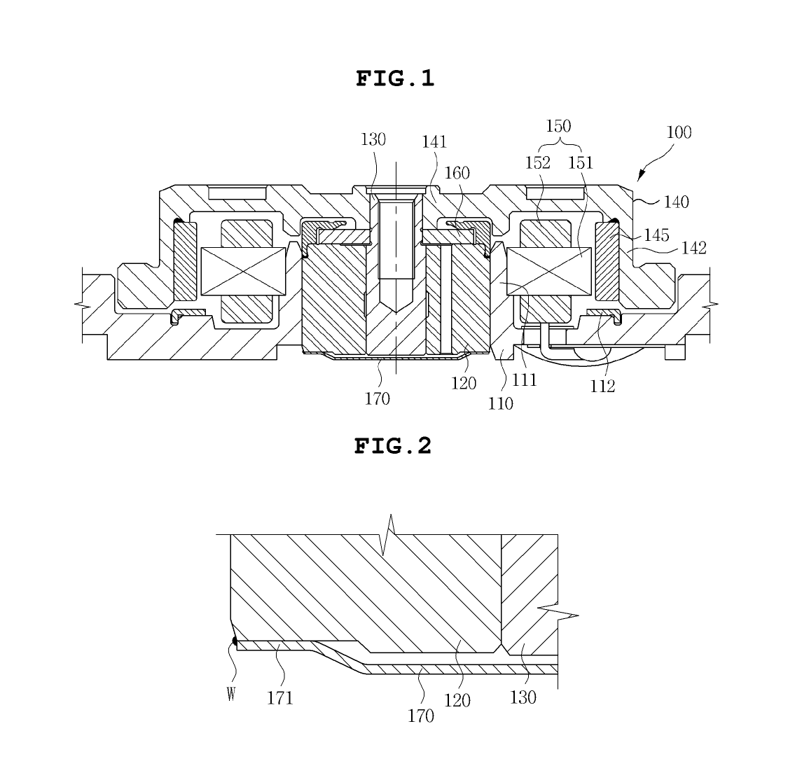

FIG. 1 is a schematic cross-sectional view of a spindle motor according to a preferred embodiment of the present invention.

Referring to FIG. 1, the spindle motor 100 according to the preferred embodiment of the present invention is configured to include a base 110, a sleeve 120, a shaft 130, a rotor 140, and a stator 150.

The base 110, which is installed in a device such as a hard disk drive (not shown), or the like, provides a space capable of receiving members configuring the motor therein. As shown in FIG. 1, the base 110 includes a support part 111 having a cylindrical shape formed at a central portion thereof, and a sleeve 120 to be described below is inserted into a hollow part formed at a central portion of the support part 111 to thereby be coupled thereto.

In addition, the base 110 includes a pulling plate 112 made of a magnetic material and adhered to an upper surface thereof, and preferably, the pulling plate 112 is disposed at a portion adjacent to a magnet 145 to be described below, such that attractive force by magnetic force acts between the pulling plate 112 and the magnet 145.

The sleeve 120 may be inserted into the support part 111 of the base 110 to be assembled as described above. In addition, the sleeve 120 has an entirely cylindrical shape to rotatably support the shaft 130 therein.

The sleeve 120 forms fluid dynamic pressure bearings at an inner peripheral surface spaced apart from the shaft 130 by a predetermined interval and a bearing surface contacting a thrust plate 160. The fluid dynamic pressure bearing motor is covered at a lower portion of bearing components, more specifically, by a cover 170 preventing separation of the sleeve 120 and the shaft 130 from each other.

The cover 170 is coupled to the sleeve 120 by a horizontal butt welding method, and a detailed description thereof will be provided with reference to FIG. 2.

The shaft 130 supports a hub 141 and is inserted into the sleeve 120 to thereby be rotatably supported by the sleeve 120, and an upper side portion thereof is provided with the thrust plate 160.

In other words, preferably, the shaft 130 may be spaced apart from the inner peripheral surface of the sleeve 120 by a predetermined interval to maintain a non-contact state in order to reduce contact friction force with the inner peripheral surface of the sleeve 120. Further, a clearance between the sleeve 120 and the shaft 130 is filled with fluid, for example, oil, and friction with the sleeve 120 at the time of rotation of the shaft 130 may be reduced via the oil.

In addition, the rotor 140 having a cup shape includes the hub 141 and a skirt part 142 on which the magnet 145 is mounted, and shaft 130 is disposed at a vertical axis line coinciding with the center of rotation of the hub 141.

The rotor 140, which forms an electric field for rotation of the hub 141 and is a rotating structure rotatably provided with respect to the stator 150, includes a ring shaped magnet 145 disposed to face a core 151 by a predetermined interval at an inner peripheral surface of the skirt part 142, wherein the magnet 145 forming a magnetic field generates electromagnetic force between the magnet 145 and the electric field formed in a coil 152. Through this electromagnetic force, the rotor 140 of the spindle motor rotates. The hub 141 enables rotation of a disk (not shown) for signal recording/reproducing.

The stator 150 is a fixed structure that includes the ring shaped core 151 fixedly disposed on the base 110 and the coil 152 wound around the core 151 to generate the electric field.

FIG. 2 is a partially enlarged view of the spindle motor shown in FIG. 1.

The present invention is characterized in that the sleeve 120 and the cover 170 are coupled to each other by the horizontal butt welding method.

In other words, according to the present invention, a welding part W of the sleeve 120 and the cover 170 arranged to face each other at a lower portion of the sleeve 120 is welded in a horizontal direction. The welding part W is formed at an edge at which an outer peripheral surface of the cover 170, more specifically, an upper edge of the cover 170 and an outer peripheral surface of the lower portion of the sleeve 120 contact each other in a circumferential direction to have a ring shape.

For reference, the cover 170 may be formed to correspond to the lower portion of the sleeve 120 so as to sufficiently receive the lower portion of the sleeve 120.

However, two components arranged to face each other, that is, the sleeve 120 and the cover 170 have the same size as each other so as to easily performing the horizontal butt welding. For example, an outer diameter of the lower portion of the sleeve 120 is the same as that of the edge of the cover 170, and the outer peripheral surface of the sleeve 120 and an outer peripheral surface of the cover 170 are linearly arranged, such that welding quality of the welding part W may be improved.

Selectively, the cover 170 is formed with a flat surface at a central portion thereof and a wing part 171 bent near the outer peripheral surface thereof, thereby generally having a dish or saucer shape. Here, the wing part 171 of the cover is provided at the outer peripheral surface and may be referred as the edge of the cover.

The horizontal butt welding means that the sleeve 120 and the cover 170 are welded in the horizontal direction as described above. That is, an edge of a lower end of the sleeve and an edge of an upper end of the cover are firmly coupled to each other via resistance heat, such that deformation by energy is induced in the axial direction, thereby making it possible to minimized deformation in the circumferential direction.

The cover 170 secures a predetermined space in the axial direction through the wing part 171, such that the cover may have a space with respect to deformation by the horizontal butt welding in the axial direction.

As set forth above, according to the present invention, the sleeve and the cover arranged to face each other in the vertical direction may be coupled to each other by horizontal butt welding.

According to the present invention, in order to arrange the sleeve and the cover in parallel with each other, there is no need to separately include a seating groove part at the sleeve as the prior art, thereby making it possible to simplify the structure.

In addition, according to the present invention, deformation in the circumferential direction may be minimized by horizontal butt welding, such that rotational characteristics of the motor may not be affected.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft;
a sleeve having a hollow cylindrical shape so as to rotatably support the shaft; and
a cover arranged in parallel with a lower portion of the sleeve to close an opened lower portion of the sleeve;
wherein a junction of an outer peripheral surface of the cover and an outer peripheral surface of the sleeve is fixed by a horizontal butt welding method.

2. The spindle motor as set forth in claim 1, wherein an edge of the cover has the same shape as that of the outer peripheral surface of the lower portion of the sleeve.

3. The spindle motor as set forth in claim 1, wherein in the horizontal butt welding method, a ring shaped welding part is formed along the junction of the sleeve and the cover arranged in an axial direction.

4. The spindle motor as set forth in claim 1, wherein the cover is provided with a flat surface and a wing part bent near an outer peripheral surface of the flat surface.
